(19) United States
(12) Patent Application Publication
(10) Pub. No.: US 2025/0175241 A1
(43) Pub. Date: May 29, 2025

(54) CONTROL APPARATUS, TERMINAL APPARATUS, CONTROL METHOD, AND NON-TRANSITORY COMPUTER-READABLE MEDIUM

(71) Applicant: NEC Corporation, Minato-ku, Tokyo (JP)

(72) Inventors: Kenji WAKAFUJI, Tokyo (JP); Ryota Nihei, Tokyo (JP); Kohei Yoshida, Tokyo (JP); Junichi Funada, Tokyo (JP)

(73) Assignee: NEC Corporation, Minato-ku, Tokyo (JP)

(21) Appl. No.: 18/836,441

(22) PCT Filed: Mar. 28, 2022
(86) PCT No.: PCT/JP2022/014981

§ 371 Date: Aug. 7, 2024

(51) Int. Cl. H04B 7/08; H04B 7/06; H04B 17/318

(52) U.S. Cl. CPC H04B 7/0897; H04B 7/06952; H04B 17/318

(57) ABSTRACT

A sweep control unit in a control apparatus performs sweep control for sequentially matching a direction of a reception beam of a communication terminal with each of a plurality of measurement directions included in a reception sweep range. An acquisition unit acquires received signal strength in each measurement direction. An acquisition unit acquires a result of demodulating the received signal in each measurement direction. A specifying unit specifies a direction of a desired wave and a direction of an interference wave on the basis of the received signal strength and the result of demodulating. A determination unit determines a direction of use of the reception beam on the basis of the direction of the desired wave and the direction of the interference wave that are specified by the specifying unit.

### TECHNICAL FIELD

The present disclosure relates to a control apparatus, a terminal apparatus, a control method, and a non-transitory computer-readable medium.

### BACKGROUND ART

A technique for controlling a directivity direction of an antenna included in a communication terminal is proposed (for example, Patent Literature 1).

### CITATION LIST

### Patent Literature

Patent Literature 1: Japanese Unexamined Patent Application Publication No. 2009-071497

### SUMMARY OF INVENTION

### Technical Problem

The present inventor has found that, the technique disclosed in Patent Literature 1 has a problem that communication quality of a communication terminal may be degraded. The present inventor has found that degradation in communication quality of a communication terminal can be suppressed by specifying a direction of a desired wave and a direction of an interference wave and determining a direction of a reception beam on the basis of the specified directions of the desired wave and the interference wave.

An object of the present disclosure is to provide a control apparatus, a terminal apparatus, a control method, and a non-transitory computer-readable medium that are able to suppress degradation in communication quality of a terminal apparatus.

### Solution to Problem

A control apparatus according to a first aspect is a control apparatus that controls a communication terminal and includes
a sweep control means for performing sweep control for sequentially matching a direction of a reception beam of the communication terminal with each measurement direction included in a sweep range,
a first acquisition means for acquiring received signal strength in each measurement direction,
a second acquisition means for acquiring a result of demodulating a received signal in each measurement direction,
a first specifying means for specifying a direction of a desired wave and a direction of an interference wave on the basis of the received signal strength and the result of demodulating,
a determination means for determining a direction of use of a reception beam on the basis of the specified directions of the desired wave and the interference wave, and
a beam control means for controlling a direction of a reception beam of the communication terminal on the basis of the determined direction of use of the reception beam.

A control method according to a second aspect is a control method to be performed by a control apparatus configured to control a communication terminal and includes
performing sweep control for sequentially matching a direction of a reception beam of the communication terminal with each measurement direction included in a sweep range,
acquiring received signal strength in each measurement direction,
acquiring a result of demodulating a received signal in each measurement direction,
specifying a direction of a desired wave and a direction of an interference wave on the basis of the received signal strength and the result of demodulating,
determining a direction of a reception beam on the basis of the specified directions of the desired wave and the interference wave, and
controlling a direction of use of a reception beam of the communication terminal on the basis of the determined direction of the reception beam.

A non-transitory computer-readable medium according to a third aspect stores a program causing a control apparatus that controls a communication terminal to perform processing of
performing sweep control for sequentially matching a direction of a reception beam of the communication terminal with each measurement direction included in a sweep range,
acquiring received signal strength in each measurement direction,
acquiring a result of demodulating a received signal in each measurement direction,
specifying a direction of a desired wave and a direction of an interference wave on the basis of the received signal strength and the result of demodulating,
determining a direction of a reception beam on the basis of the specified directions of the desired wave and the interference wave, and
controlling a direction of use of a reception beam of the communication terminal on the basis of the determined direction of the reception beam.

### Advantageous Effects of Invention

The present disclosure can provide a control apparatus, a terminal apparatus, a control method, and a non-transitory computer-readable medium that are able to suppress degradation in communication quality of a terminal apparatus.

### BRIEF DESCRIPTION OF DRAWINGS

FIG. 1 is a block diagram illustrating an example of a communication terminal in a first example embodiment;

FIG. 2 is a block diagram illustrating an example of a control apparatus in the first example embodiment;

FIG. 3 is a flowchart illustrating an example of a processing operation of the control apparatus in the first example embodiment;

FIG. 4 is a block diagram illustrating an example of a communication terminal in a second example embodiment;

FIG. 5 is a block diagram illustrating an example of a control apparatus in the second example embodiment;

FIG. 6 is a flowchart illustrating an example of a processing operation of the control apparatus in the second example embodiment;

FIG. 7 is a block diagram illustrating an example of a communication terminal in a third example embodiment;

FIG. 8 is a block diagram illustrating an example of a control apparatus in the third example embodiment; and

FIG. 9 is a diagram illustrating a hardware configuration example of a control apparatus.

### EXAMPLE EMBODIMENT

Hereinafter, example embodiments of the present disclosure are described with reference to the drawings. The following description and drawings have been appropriately omitted and simplified in order to clarify the description. In the following each drawing, the same elements are denoted by the same reference numerals, and redundant descriptions are omitted as needed. In the present disclosure, unless specified otherwise, “at least one of A or B (A/B)” may mean any one of A or B, or may mean both A and B. Likewise, when “at least one” is used for three or more elements, it may mean any one of these elements, or may mean any plurality of elements (including all elements).

### First Example Embodiment

### Configuration Example of Terminal Apparatus

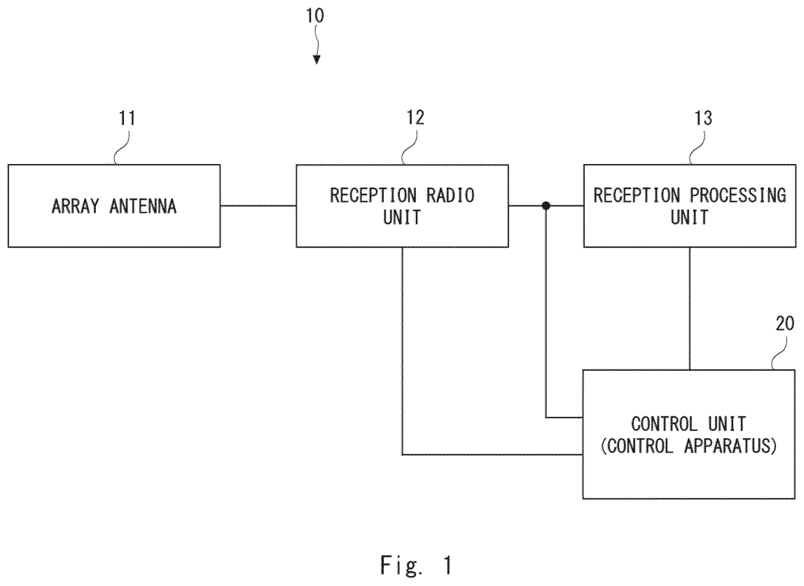

FIG. 1 is a block diagram illustrating an example of a communication terminal in a first example embodiment. In FIG. 1, a communication terminal 10 includes an array antenna 11, a reception radio unit 12, a reception processing unit 13, and a control unit (control apparatus) 20.

The array antenna 11 includes a plurality of antenna elements. The array antenna 11 outputs signals received by each antenna element to the reception radio unit 12.

The reception radio unit 12 performs a radio reception process (down-conversion, analog-to-digital conversion, or the like) on a radio signal received from the array antenna 11. The reception radio unit 12 includes a plurality of phase shifters associated with the plurality of antenna elements. The plurality of phase shifters adjust a phase of a received signal on the basis of a reception beamforming weight received from the control unit 20. The direction of a reception beam of the communication terminal 10 is controlled by the reception beamforming weight. For example, the reception radio unit 12 may perform phase adjustment after down-conversion, and then perform analog-to-digital conversion.

The reception radio unit 12 outputs a received signal (for example, a baseband signal) obtained after the radio reception process and the phase adjustment process to the reception processing unit 13 and the control unit 20.

The reception processing unit 13 performs a reception process (demodulation process or the like) on the received signal received from the reception radio unit 12.

The control unit (control apparatus) 20 performs various types of control of the communication terminal 10.

### Configuration Example of Control Apparatus

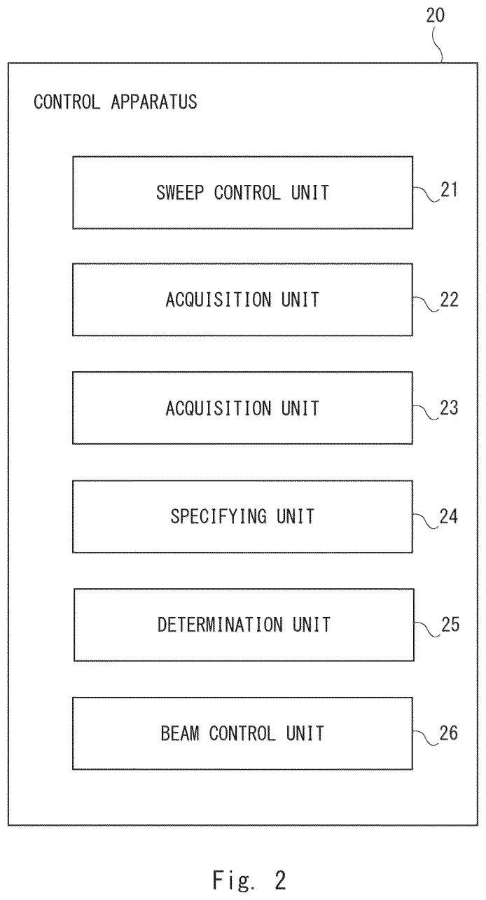

FIG. 2 is a block diagram illustrating an example of the control apparatus in the first example embodiment. In FIG. 2, the control apparatus (control unit) 20 includes a sweep control unit 21, acquisition units 22 and 23, a specifying unit 24, a determination unit 25, and a beam control unit 26.

The sweep control unit 21 performs sweep control for sequentially matching the direction of a reception beam (hereinafter, sometimes referred to as a “reception beam direction”) of the communication terminal 10 with each of a plurality of measurement directions included in a “reception sweep range”. The sweep control unit 21 outputs a sweep control signal for controlling the reception beam direction to the reception radio unit 12 so that the reception beam direction of the communication terminal 10 faces each measurement direction. The “sweep control signal” includes reception beamforming weights associated with the plurality of measurement directions included in the “reception sweep range”.

The acquisition unit 22 acquires received signal strength in each measurement direction. For example, the acquisition unit 22 may acquire (measure) received signal strength on the basis of the received signal received from the reception radio unit 12. Alternatively, when the communication terminal 10 has received signal strength measurement unit (not illustrated), the acquisition unit 22 may acquire received signal strength in each measurement direction from the received signal strength measurement unit (not illustrated).

The acquisition unit 23 acquires a “result of demodulating” the received signal in each measurement direction from the reception processing unit 13. The “result of demodulating” may be, for example, information indicating whether the demodulation is possible (success or failure), or information indicating whether the received signal is a signal addressed to the terminal apparatus 10. When the measurement direction matches a direction in which a communication partner of the communication terminal 10 is located, since a desired wave can be received by a reception beam, it is conceivable that the demodulation process is successful or destination information with the communication apparatus 10 as a destination is acquirable. On the other hand, when the measurement direction matches a direction in which a communication apparatus not being a communication partner of the communication terminal 10 is located, since an interference wave can be received by a reception beam, it is conceivable that the demodulation process is not successful or destination information with the communication apparatus 10 as a destination is not acquirable.

The specifying unit 24 specifies the direction of a desired wave and the direction of an interference wave on the basis of the received signal strength and the result of demodulating. For example, the specifying unit 24 specifies one or more peaks of the received signal strength in the reception sweep range. Subsequently, the specifying unit 24 sequentially selects a measurement direction associated with each peak as a “determination target direction”, and specifies the determination target direction as the direction of the desired wave when the result of demodulating the received signal in the “determination target direction” indicates that the demodulation is possible (demodulation is successful). When the result of demodulating the received signal in the “determination target direction” indicates that the demodulation is not possible (demodulation is a failure), the specifying unit 24 specifies the determination target direction as the direction of the interference wave.

The determination unit 25 determines the direction of use of the reception beam on the basis of the direction of the desired wave and the direction of the interference wave that are specified by the specifying unit 24. For example, the determination unit 25 determines, as the “direction of use” of the reception beam, a direction of a desired wave in which an angle formed with the specified direction of the interference wave is equal to or greater than a predetermined value and associated received signal strength is the highest among directions of one or more desired waves specified by the specifying unit 24.

The beam control unit 26 controls the reception beam direction of the communication terminal 10 on the basis of the “direction of use” of the reception beam determined by the determination unit 25. For example, the beam control unit 26 outputs a beam control signal for controlling the reception beam direction to the reception radio unit 12 so that the reception beam direction of the communication terminal 10 faces the “direction of use”. The “beam control signal” includes a reception beamforming weight associated with the “direction of use”.

### Operation Example of Control Apparatus

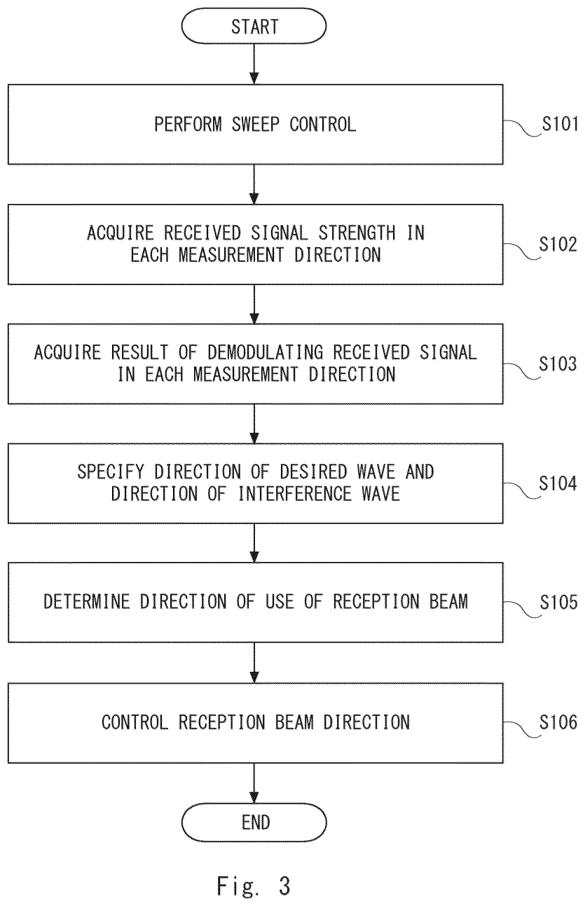

FIG. 3 is a flowchart illustrating an example of a processing operation of the control apparatus in the first example embodiment.

The sweep control unit 21 performs sweep control for sequentially matching the reception beam direction of the communication terminal 10 with each of a plurality of measurement directions included in the reception sweep range (step S101).

The acquisition unit 22 acquires received signal strength in each measurement direction (step S102).

The acquisition unit 23 acquires the result of demodulating a received signal in each measurement direction from the reception processing unit 13 (step S103).

The specifying unit 24 specifies the direction of a desired wave and the direction of an interference wave on the basis of the received signal strength and the result of demodulating (step S104).

The determination unit 25 determines the direction of use of a reception beam on the basis of the direction of the desired wave and the direction of the interference wave that are specified by the specifying unit 24 (step S105).

The beam control unit 26 controls the reception beam direction of the communication terminal 10 on the basis of the “direction of use” of the reception beam that is determined by the determination unit 25 (step S106).

As described above, according to the first example embodiment, the specifying unit 24 in the control apparatus 10 specifies the direction of the desired wave and the direction of the interference wave on the basis of the received signal strength and the result of demodulating. The determination unit 25 determines the direction of use of the reception beam on the basis of the direction of the desired wave and the direction of the interference wave that are specified by the specifying unit 24.

With such a configuration of the control apparatus 10, the direction of use of the reception beam can be determined on the basis of the direction of the interference wave as well as the direction of the desired wave, so that the direction of the desired wave that is less affected by the interference wave can be determined as the direction of the reception beam. Thus, degradation in the communication quality of the terminal apparatus can be suppressed.

### Second Example Embodiment

A second example embodiment relates to a more specific example embodiment.

### Configuration Example of Terminal Apparatus

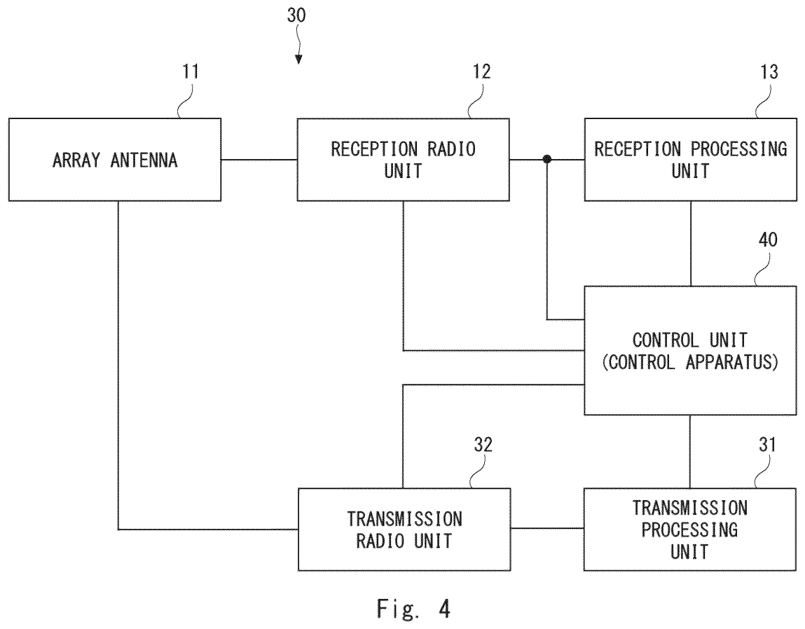

FIG. 4 is a block diagram illustrating an example of a communication terminal in the second example embodiment. In FIG. 4, a communication terminal 30 includes an array antenna 11, a reception radio unit 12, a reception processing unit 13, a transmission processing unit 31, a transmission radio unit 32, and a control unit (control apparatus) 40.

The transmission processing unit 31 outputs a transmission signal (for example, a baseband signal) to the transmission radio unit 32.

The transmission radio unit 32 performs a radio transmission process (analog-to-digital conversion, up-conversion, or the like) on a transmission signal received from the transmission processing unit 31. The transmission radio unit 32 includes a plurality of phase shifters associated with a plurality of antenna elements. The plurality of phase shifters adjust a phase of the transmission signal on the basis of a transmission beamforming weight received from the control unit 40. The direction of a transmission beam of the communication terminal 10 is controlled by the transmission beamforming weight. For example, the transmission radio unit 32 may perform phase adjustment after digital-to-analog conversion, and then perform up-conversion.

The control unit (control apparatus) 40 performs various types of control of the communication terminal 30.

### Configuration Example of Control Apparatus

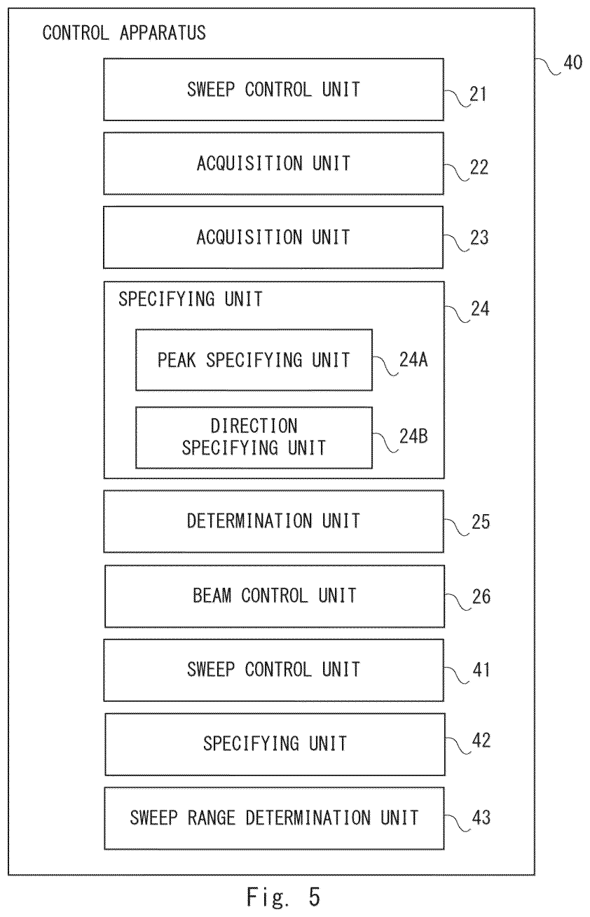

FIG. 5 is a block diagram illustrating an example of the control apparatus in the second example embodiment. In FIG. 5, the control apparatus (control unit) 40 includes a sweep control unit 21, acquisition units 22 and 23, a specifying unit 24, a determination unit 25, a beam control unit 26, a sweep control unit 41, a specifying unit 42, and a sweep range determination unit 43.

The sweep control unit 41 performs transmission sweep control for sequentially matching the direction of a transmission beam (hereinafter, sometimes referred to as a “transmission beam direction”) of the communication terminal 30 with each of a plurality of transmission directions included in a “transmission sweep range (sweepable direction range)”. The “transmission sweep range” may be, for example, 360 degree in a horizontal direction and around the communication terminal 30. The sweep control unit 41 outputs a transmission sweep control signal for controlling the transmission beam direction to the transmission radio unit 32 so that the transmission beam direction of the communication terminal 30 faces each transmission direction. The “transmission sweep control signal” includes transmission beamforming weights associated with the plurality of transmission directions included in the “transmission sweep range”.

The specifying unit 42 specifies a direction, in which a radio wave shielding object around the communication terminal 30 is located, on the basis of power of a reflected wave of a transmission signal reflected by the radio wave shielding object, the transmission signal being transmitted in each transmission direction by the transmission sweep control in order to specify the direction in which the radio wave shielding object is located. For example, the specifying unit 42 may specify a direction, in which the power of the reflected wave exceeds a shielding object determination threshold value, as the direction in which the radio wave shielding object is located.

The sweep range determination unit 43 determines a “reception sweep range” to be used by the sweep control unit 21 by excluding the direction in which the radio wave shielding object is located, which is specified by the specifying unit 42, from the “transmission sweep range (sweepable direction range)”.

The sweep control unit 21 performs sweep control for sequentially matching the reception beam direction of the communication terminal 30 with each of a plurality of measurement directions included in the “reception sweep range”.

The acquisition unit 22 acquires received signal strength in each measurement direction.

The acquisition unit 23 acquires a “result of demodulating” the received signal in each measurement direction from the reception processing unit 13.

The specifying unit 24 specifies the direction of a desired wave and the direction of an interference wave on the basis of the received signal strength and the result of demodulating. The specifying unit 24 includes a peak specifying unit 24A and a direction specifying unit 24B.

The peak specifying unit 24A specifies one or more peaks of received signal strength in the reception sweep range.

The direction specifying unit 24B sequentially selects a measurement direction associated with each peak as a “determination target direction”, and specifies the determination target direction as the direction of the desired wave when the result of demodulating the received signal in the “determination target direction” indicates that the demodulation is possible (demodulation is successful). When the result of demodulating the received signal in the “determination target direction” indicates that the demodulation is not possible (demodulation is a failure), the direction specifying unit 24B specifies the determination target direction as the direction of the interference wave.

The determination unit 25 determines the direction of use of the reception beam on the basis of the direction of the desired wave and the direction of the interference wave that are specified by the specifying unit 24.

The beam control unit 26 controls the reception beam direction of the communication terminal 10 on the basis of the “direction of use” of the reception beam that is determined by the determination unit 25.

### Operation Example of Control Apparatus

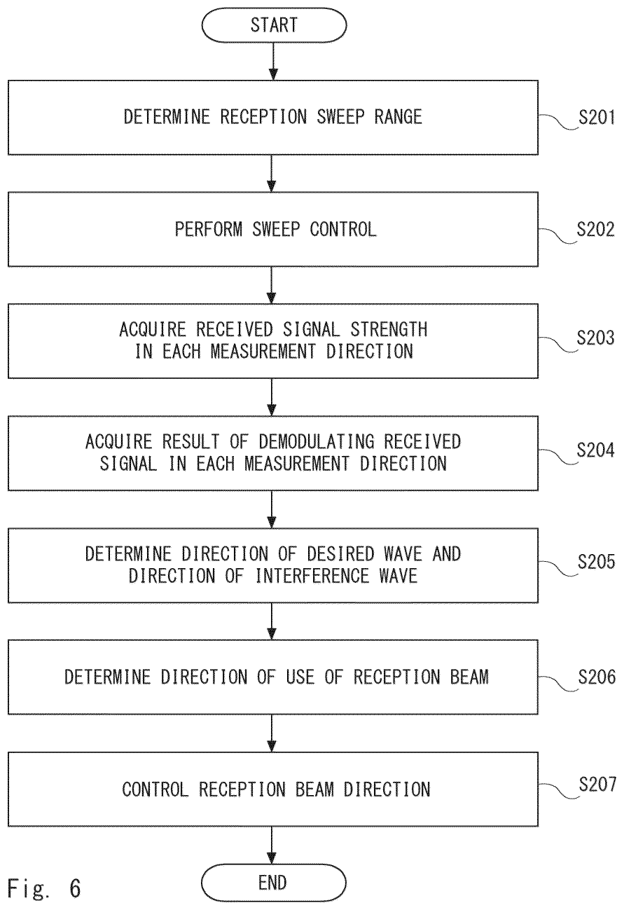

FIG. 6 is a flowchart illustrating an example of a processing operation of the control apparatus in the second example embodiment.

The control apparatus (control unit) 40 determines a reception sweep range (step S201). Specifically, the sweep control unit 41 performs transmission sweep control for sequentially matching the transmission beam direction of the communication terminal 30 with each of a plurality of transmission directions included in a transmission sweep range (step S201). The specifying unit 42 specifies the direction, in which a radio wave shielding object around the communication terminal 30 is located, on the basis of the power of a reflected wave of a transmission signal reflected by the radio wave shielding object, the transmission signal being transmitted in each transmission direction by the transmission sweep control in order to specify the direction in which the radio wave shielding object is located (step S201). The sweep range determination unit 43 determines the “reception sweep range” to be used by the sweep control unit 21 by excluding the direction in which the radio wave shielding object is located, which is specified by the specifying unit 42, from the transmission sweep range (step S201).

Since steps S202 to S207 are the same as steps S101 to S106 of the first example embodiment, a description thereof is omitted. When, from an absolute position of the communication terminal 30 (hereinafter, sometimes referred to as an “initial position” of the communication terminal 30) at a certain time point (first timing) when the “direction of use” of a reception beam is determined and an absolute state of a reference surface of the communication terminal 30 (hereinafter, sometimes referred to as an “initial state of the reference surface”), the position of the communication terminal 30 and the state of the reference surface are changed due to the movement or rotation of the communication terminal 30, the processing flow illustrated in FIG. 6 may be started. Even when the communication terminal 30 does not move or rotate and received signal strength of a desired wave becomes less than a predetermined threshold value, or even when communication quality of the desired wave becomes less than the predetermined threshold value, the processing flow illustrated in FIG. 6 may also be started. However, in such a case, the processing flow illustrated in FIG. 6 may also be started from the process of step S202 after the process of step S201 is skipped.

When the position of the communication terminal 30 and the state of the reference surface at a second timing after the first timing deviate from the initial position” of the communication terminal 30 and the “initial state of the reference surface”, the beam control unit 26 may control the reception beam direction by correcting the direction of use of the reception beam on the basis of the amount of deviation.

### Third Example Embodiment

A third example embodiment relates to a variation of a method for determining a reception sweep range.

### Configuration Example of Terminal Apparatus

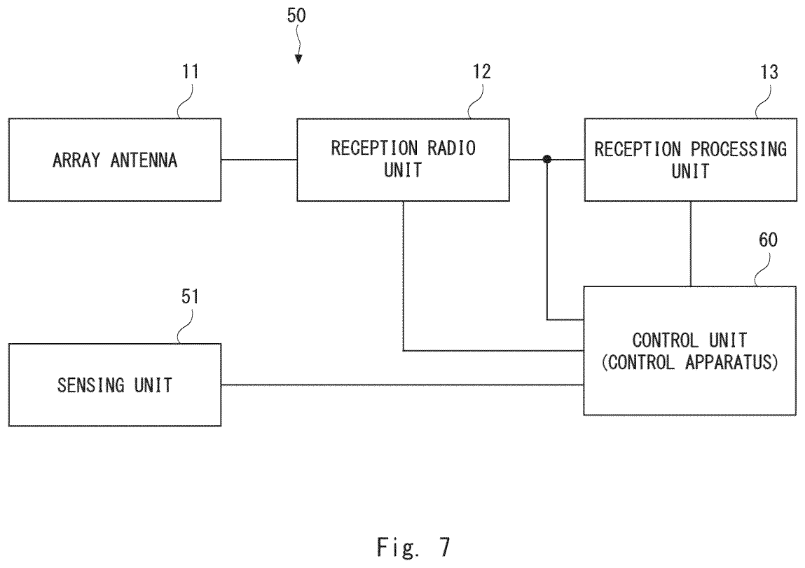

FIG. 7 is a block diagram illustrating an example of a communication terminal in the third example embodiment. In FIG. 7, a communication terminal 50 includes an array antenna 11, a reception radio unit 12, a reception processing unit 13, a sensing unit 51, and a control unit (control apparatus) 60.

The sensing unit 51 senses a “sensing range” and outputs a sensing result to the control unit (control apparatus) 60. The sensing unit 51 is, for example, a thermal sensor, a camera, or the like. The “sensing range” may be, for example, 360 degree in a horizontal direction and around the communication terminal 30.

The control unit (control apparatus) 60 performs various types of control of the communication terminal 50.

### Configuration Example of Control Apparatus

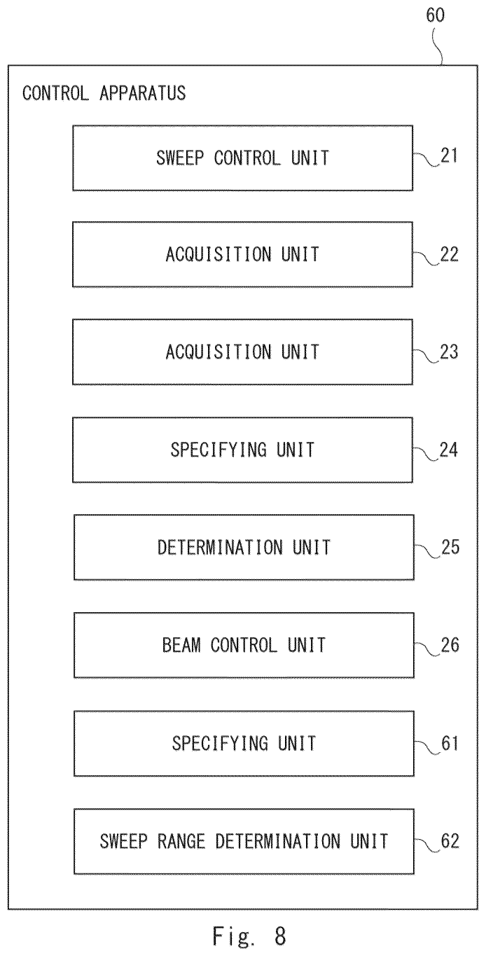

FIG. 8 is a block diagram illustrating an example of the control apparatus in the third example embodiment. In FIG. 8, the control apparatus (control unit) 60 includes a sweep control unit 21, acquisition units 22 and 23, a specifying unit 24, a determination unit 25, a beam control unit 26, a specifying unit 61, and a sweep range determination unit 62.

The specifying unit 61 specifies a direction, in which a radio wave shielding object around the communication terminal 30 is located, on the basis of a sensing result.

For example, when the sensing unit 51 is a thermal sensor, the specifying unit 61 specifies the direction, in which the radio wave shielding object around the communication terminal 30 is located, on the basis of information on a temperature around the communication terminal 30. Thus, for example, on the basis of the body temperature of a user holding the communication terminal 30, a direction in which the user is present can be specified.

For example, when the sensing unit 51 is a camera, the specifying unit 61 specifies the direction, in which the radio wave shielding object around the communication terminal 30 is located, on the basis of an image.

The sweep range determination unit 62 determines a “reception sweep range” to be used by the sweep control unit 21 by excluding the direction in which the radio wave shielding object is located, which is specified by the specifying unit 61, from the “sensing range”.

### Operation Example of Control Apparatus

Since the processing operation of the control apparatus 60 of the third example embodiment is basically the same as the processing operation of the control apparatus 40 of the second example embodiment, a description thereof is omitted.

### Other Example Embodiments

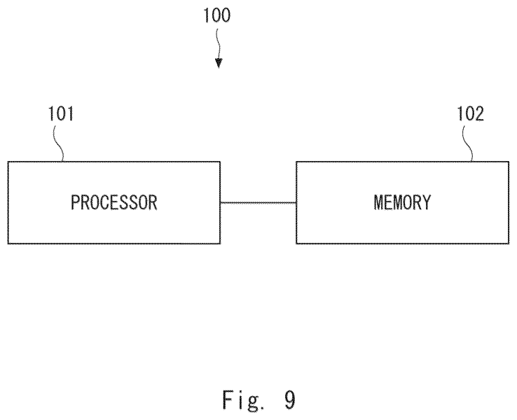

FIG. 9 is a diagram illustrating a hardware configuration example of a control apparatus. A control apparatus 100 in FIG. 9 includes a processor 101 and a memory 102. The processor 101 may be, for example, a microprocessor, a micro processing unit (MPU), or a central processing unit (CPU). The processor 101 may include a plurality of processors. The memory 102 is composed of a combination of a volatile memory and a nonvolatile memory. The memory 102 may include a storage separated from the processor 101. In such a case, the processor 101 may access the memory 102 via an I/O interface (not illustrated).

The control apparatuses 20, 40, and 60 of the first example embodiment to the third example embodiment may each have the hardware configuration illustrated in FIG. 9. The sweep control unit 21, the acquisition units 22 and 23, the specifying unit 24, the determination unit 25, the beam control unit 26, the sweep control unit 41, the specifying units 42 and 61, and the sweep range determination units 43 and 62 of the control apparatuses 20, 40, and 60 of the first example embodiment to the third example embodiment may be implemented with the processor 101 that reads a program stored in the memory 102 and executes the read program. The program can be stored using various types of non-transitory computer-readable media, and supplied to the control apparatuses 20, 40, and 60. Examples of the non-transitory computer-readable media include magnetic recording media (for example, flexible disks, magnetic tapes, and hard disk drives), and magnetooptical recording media (for example, magnetooptical disks). Examples of the non-transitory computer-readable medium further include CD-ROMs (Read Only Memories), CD-Rs, and CD-RWs. Examples of the non-transitory computer-readable medium further include semiconductor memories. The semiconductor memories include, for example, mask ROMs, programmable ROMs (PROMs), erasable PROMs (EPROMs), flash ROMs, and random access memories (RAMs). The program may be supplied to the control apparatuses 20, 40, and 60 via various types of transitory computer-readable media. Examples of the transitory computer-readable media include electrical signals, optical signals, and electromagnetic waves. The transitory computer-readable medium can supply the program to the control apparatuses 20, 40, and 60 via wired communication channels such as electric wires and optical fibers, or wireless communication channels.

The present invention has been described with reference to the example embodiments, but the present invention is not limited to the example embodiments. Various changes that can be understood by a person skilled in the art within the scope of the invention can be made to the configurations and details of the present invention.

### REFERENCE SIGNS LIST

10 COMMUNICATION TERMINAL
11 ARRAY ANTENNA
12 RECEPTION RADIO UNIT
13 RECEPTION PROCESSING UNIT
20 CONTROL UNIT (CONTROL APPARATUS)
21 SWEEP CONTROL UNIT
22 ACQUISITION UNIT
23 ACQUISITION UNIT
24 SPECIFYING UNIT
24A PEAK SPECIFYING UNIT
24B DIRECTION SPECIFYING UNIT
25 DETERMINATION UNIT
26 BEAM CONTROL UNIT
30 COMMUNICATION TERMINAL
31 TRANSMISSION PROCESSING UNIT
32 TRANSMISSION RADIO UNIT
40 CONTROL UNIT (CONTROL APPARATUS)
41 SWEEP CONTROL UNIT
42 SPECIFYING UNIT
43 SWEEP RANGE DETERMINATION UNIT
50 COMMUNICATION TERMINAL
51 SENSING UNIT
60 CONTROL UNIT (CONTROL APPARATUS)
61 SPECIFYING UNIT
62 SWEEP RANGE DETERMINATION UNIT

What is claimed is:

1. A control apparatus that controls a communication terminal, the control apparatus comprising:
at least one memory storing instructions, and
at least one processor configured to execute the instructions to;
perform sweep control for sequentially matching a direction of a reception beam of the communication terminal with each measurement direction included in a sweep range;
acquire received signal strength in each measurement direction;
acquire a result of demodulating the received signal in each measurement direction;
specify a direction of a desired wave and a direction of an interference wave, based on the received signal strength and the result of demodulating;
determine a direction of use of a reception beam, based on the specified directions of the desired wave and the interference wave; and
control a direction of a reception beam of the communication terminal, based on the determined direction of use of the reception beam.

2. The control apparatus according to claim 1, wherein the at least one processor is further configured to execute the instructions to:
specify a peak of received signal strength in the sweep range; and
when a result of demodulating the received signal in a measurement direction associated with the specified each peak indicates that the demodulation is possible, specify the measurement direction as the direction of the desired wave, and when a result of demodulating the received signal in a measurement direction associated with the specified each peak indicates that the demodulation is not possible, specify the measurement direction as the direction of the interference wave.

3. The control apparatus according to claim 2, wherein the at least one processor is further configured to execute the instructions to determine, as the direction of use of the reception beam, a direction of a desired wave in which an angle formed with a specified direction of an interference wave is equal to or greater than a predetermined value and associated received signal strength is highest among specified directions of one or more desired waves.

4. The control apparatus according to claim 1, wherein, when received signal strength in a direction of use of the reception beam is smaller than a first threshold value, the at least one processor is further configured to execute the instructions to start the sweep control.

5. The control apparatus according to claim 1, wherein, when communication quality when a direction of a reception beam of the communication terminal is matched with the direction of use of the reception beam is lower than a predetermined level, the at least one processor is further configured to execute the instructions to start the sweep control.

6. The control apparatus according to claim 1, wherein the at least one processor is further configured to execute the instructions to:
specify a direction in which a radio wave shielding object around the communication terminal is located; and
determine the sweep range by excluding a range of the direction in which the radio wave shielding object is located from a sweepable direction range.

7. A terminal apparatus comprising the control apparatus according to claim 1.

8. A control method to be performed by a control apparatus that controls a communication terminal, the control method comprising:
performing sweep control for sequentially matching a direction of a reception beam of the communication terminal with each measurement direction included in a sweep range;
acquiring received signal strength in each measurement direction;
acquiring a result of demodulating the received signal in each measurement direction;
specifying a direction of a desired wave and a direction of an interference wave, based on the received signal strength and the result of demodulating;
determining a direction of use of a reception beam, based on the specified directions of the desired wave and the interference wave; and
controlling a direction of a reception beam of the communication terminal, based on the determined direction of use of the reception beam.

9. A non-transitory computer-readable medium storing a program causing a control apparatus that controls a communication terminal to perform processing of:
performing sweep control for sequentially matching a direction of a reception beam of the communication terminal with each measurement direction included in a sweep range;
acquiring received signal strength in each measurement direction;
acquiring a result of demodulating the received signal in each measurement direction;
specifying a direction of a desired wave and a direction of an interference wave, based on the received signal strength and the result of demodulating;
determining a direction of use of a reception beam, based on the specified directions of the desired wave and the interference wave; and
controlling a direction of a reception beam of the communication terminal, based on the determined direction of use of the reception beam.

10. The control method according to claim 8, wherein the specifying includes:
specifying a peak of received signal strength in the sweep range; and
when a result of demodulating the received signal in a measurement direction associated with the specified each peak indicates that the demodulation is possible, specifying the measurement direction as the direction of the desired wave, and when a result of demodulating the received signal in a measurement direction associated with the specified each peak indicates that the demodulation is not possible, specifying the measurement direction as the direction of the interference wave.

11. The control method according to claim 10, wherein the determining includes determining, as the direction of use of the reception beam, a direction of a desired wave in which an angle formed with a specified direction of an interference wave is equal to or greater than a predetermined value and associated received signal strength is highest among specified directions of one or more desired waves.

12. The control method according to claim 8, wherein, when received signal strength in a direction of use of the reception beam is smaller than a first threshold value, the sweep control is started.

13. The control method according to claim 8, wherein, when communication quality when a direction of a reception beam of the communication terminal is matched with the direction of use of the reception beam is lower than a predetermined level, the sweep control is started.

14. The control method according to claim 8, further comprising:
specifying a direction in which a radio wave shielding object around the communication terminal is located; and
determining the sweep range by excluding a range of the direction in which the radio wave shielding object is located from a sweepable direction range.

15. The non-transitory computer-readable medium according to claim 9, wherein the specifying includes:
specifying a peak of received signal strength in the sweep range; and
when a result of demodulating the received signal in a measurement direction associated with the specified each peak indicates that the demodulation is possible, specifying the measurement direction as the direction of the desired wave, and when a result of demodulating the received signal in a measurement direction associated with the specified each peak indicates that the demodulation is not possible, specifying the measurement direction as the direction of the interference wave.

16. The non-transitory computer-readable medium according to claim 15, wherein the determining includes determining, as the direction of use of the reception beam, a direction of a desired wave in which an angle formed with a specified direction of an interference wave is equal to or greater than a predetermined value and associated received signal strength is highest among specified directions of one or more desired waves.

17. The non-transitory computer-readable medium according to claim 9, wherein, when received signal strength in a direction of use of the reception beam is smaller than a first threshold value, the sweep control is started.

18. The non-transitory computer-readable medium according to claim 9, wherein, when communication quality when a direction of a reception beam of the communication terminal is matched with the direction of use of the reception beam is lower than a predetermined level, the sweep control is started.

19. The non-transitory computer-readable medium according to claim 9, wherein the processing further comprises:
specifying a direction in which a radio wave shielding object around the communication terminal is located; and
determining the sweep range by excluding a range of the direction in which the radio wave shielding object is located from a sweepable direction range.
